(19) United States
(12) Patent Application Publication
(10) Pub. No.: US 2023/0021889 A1
(43) Pub. Date: Jan. 26, 2023

(54) FAN MODULE FOR A SOLDERING SYSTEM, IN PARTICULAR FOR A REFLOW SOLDERING SYSTEM, AND REFLOW SOLDERING SYSTEM

(71) Applicant: ERSA GmbH, Wertheim (DE)

(72) Inventors: Uwe Hofmann, Würzburg (DE); Lothar Endress, Wertheim (DE)

(73) Assignee: ERSA GmbH, Wertheim (DE)

(21) Appl. No.: 17/868,340

(22) Filed: Jul. 19, 2022

(30) Foreign Application Priority Data
Jul. 21, 2021 (DE) 10 2021 118 835.0

(51) Int. Cl. F04D 25/06; H02K 7/14; H02K 7/00; H02K 7/08; F04D 25/08; B23K 3/08

(52) U.S. Cl. CPC F04D 25/06; H02K 7/14; H02K 7/003; H02K 7/08; F04D 25/08; B23K 3/085

(57) ABSTRACT

A fan module for a soldering system and a soldering system, in particular for a reflow soldering system, for circulating air in a process channel of the soldering system, the module having a housing-like support part, a first shaft bearing provided in or on the support part, a motor, which includes a stator and a rotor which cooperates with the stator, a rotor shaft provided on the rotor, a fan wheel provided on the rotor shaft and having a second shaft bearing for supporting the rotor shaft, wherein the fan module includes a flange plate, which in the assembled state covers a channel opening in the process channel and which includes an aperture in or on which the second shaft bearing is provided.

### BACKGROUND

The invention relates to a fan module for a soldering system, in particular for a reflow soldering system, for circulating air in a process channel of the soldering system, the module having a housing-like support part, having a first shaft bearing provided in or on the support part, having a motor, which comprises a stator and a rotor which cooperates with the stator, having a rotor shaft provided on the rotor, having a fan wheel provided on the rotor shaft and having a second shaft bearing for supporting the rotor shaft. In the known prior art, the second shaft bearing is located on a separate bearing plate, which is attached to the support part and encapsulates the motor with respect to the environment.

Using reflow soldering systems, such as those known from DE 10 2019 128 780 A1 or US 2001/0055740 A1, so-called SMD components (surface mounted devices) in particular are soldered onto the surface of printed circuit boards using solder paste. The solder paste, which is in particular a mixture of solder metal granules, flux, and pasty components, is applied or printed onto the surface of the printed circuit boards for the reflow soldering. The components to be soldered are then placed in the solder paste. In the reflow soldering process, the item to be soldered—that is, the assembly consisting of the printed circuit board, solder paste, and components to be soldered—is preheated along the process channel in the preheating zone, and is heated in the soldering zone to a temperature that is above the melting point of the solder paste. The solder paste melts as a result, and the solder points are formed. The soldered item is cooled in the cooling zone until the melted solder solidifies before the item is then removed from the reflow soldering system.

In the case of reflow soldering systems, the temperature profile required in the relevant zone and the corresponding atmospheres are provided in the process channel. Furthermore, process gases form in the process channel and are discharged from the process channel, cleaned and fed back in.

A defined air flow is achieved in the process channel with the fan modules mentioned at the outset. In particular, the process gas is discharged, passed through a filter with a condenser and returned to the process channel. The process channel as such is provided by channel components that form the process channel, such as, for example, insulated channel panels.

In known soldering systems—such as, for example, in the Ersa HOTFLOW® 3 machine sold by the applicant at the time of the application—fan motors are used which are flanged to the outside of the channel components or flange plates that form the process channel. The channel components or flange plates have an aperture with a radial shaft seals, through which the rotor shaft of the fan motor protrudes, so that the fan wheel is located inside the process channel. The positioning of the fan motors here relative to the channel components or the flange plates must be relatively precise, so that the associated rotor shaft is arranged to run coaxially with the corresponding radial shaft seals. In addition, after the rotor shaft has been guided through the channel components or the flange plate, the fan wheel is to be attached to the free end of the rotor shaft. If the particular rotor shaft and the associated radial shaft seals do not run coaxially, process gas can escape unintentionally from the channel and pose a hazard. Attaching the fan wheel to the free end of the rotor shaft also involves considerable effort.

### SUMMARY OF THE INVENTION

The object of the invention is to provide fan modules and a soldering system having fan modules that allow the fan modules to be installed and arranged in a simple yet functional manner.

This problem is solved by a fan module having the features of claim 1.

Consequently, provision is made in particular for the fan module to include a flange plate which, when installed, covers a channel opening in the process channel and which includes an aperture in which the second shaft bearing and in particular also a shaft sealing ring, for example a radial shaft sealing ring, are provided for sealing the rotor shaft. Because the flange plate is provided, there is no need to center the fan modules on the channel components of the soldering system. Because the flange plate includes the second shaft bearing and in particular also the shaft seal, the fan module can be installed in a simple manner by inserting the flange plate into the channel opening. The insertion of the flange plate into the channel opening is relatively simple because precise manufacturing tolerances or alignment with an axis or shaft is not required here. Overall, this considerably simplifies the installation and assembly of the fan modules, which can be handled as separate units. In addition, it is always ensured that the rotor shaft is aligned coaxially with the aperture and in particular also with the shaft sealing ring, because the fan module can be provided pre-assembled as a separate unit for installation in the soldering system.

Furthermore, it is advantageous if the flange plate is designed to be larger than the fan wheel in directions extending perpendicularly to the rotor shaft. Because the flange plate corresponds to the channel opening, this means that the fan wheel can easily be inserted into the channel opening, and thus into the process channel, and easily be removed therefrom. There is no need to install the fan wheel inside the process channel.

It is also advantageous if the flange plate has openings for supplying and discharging process gases. For example, filtered process gas can be introduced into the process channel through an opening, and contaminated process gas can be directed out of another opening.

Furthermore, it is advantageous if the flange plate, in particular on the side facing the process channel, has a seal for sealing the flange plate against channel components that form the process channel. The seal can be designed, for example, as a circumferential, closed ring seal or as a lip seal. This ensures that no process gas can escape between the flange plate and the channel opening after the flange plate has been inserted into the channel opening.

Furthermore, it is advantageous if the flange plate has locking portions for attachment to the channel components that form the process channel. Such locking portions can be, for example, boreholes, recesses, threaded portions, threaded pins, quick-release fasteners or the like.

Furthermore, it is advantageous if the flange plate has fastening portions for fastening heating elements and/or other components located in the process channel. Depending on the type and design of the heating elements or the other components located in the process channel, the flange plate can have correspondingly designed fastening portions such as flat planes, undercuts, boreholes, hooks, threads, etc.

It is also conceivable that the flange plate has insulation on the side facing away from the stator, i.e., on the side facing the process channel. The insulation preferably extends as far as possible over the entire inner side of the flange plate and can be designed as an insulating plate. Controlled heating or cooling of the process gas can be achieved by the insulation.

Furthermore, it is advantageous if the flange plate has a separating panel on the side facing away from the stator, which separating panel separates the inner space of the process channel from a suction space or suction channel. In this case, the insulation can be provided between the flange plate and the separating panel. By providing such a separating panel, a suction channel can be provided, for example within the process channel, through which suction channel filtered process gas can be suctioned. In addition, the fan module can be removed without removing the fan wheel, even though a suction channel is provided between the flange plate and the fan wheel.

Furthermore, it is advantageous if the separating panel has a peripheral collar pointing away from the flange plate for guiding the air flow toward the fan wheel. The collar preferably has a rounded cross section and runs at least in portions along a circular path. The process gas can advantageously be supplied to the fan wheel via such a collar.

It is advantageous if the fan wheel has a circumferential shoulder that corresponds to the collar. The circumferential shoulder can be rounded in the longitudinal section corresponding to the collar and can run at least in portions along a circular path. In the longitudinal section, the circumferential collar preferably transitions into the circumferential shoulder. In this way, too, an optimization of the air flow within the fan module can be achieved.

Furthermore, it is advantageous if the flange plate is produced using the die-casting process. A flange plate produced in this way can be provided in a relatively inexpensive manner and can meet the requirements specified for the flange plate.

The object mentioned at the outset is also achieved by a soldering system, in particular by a reflow soldering system, having one or more fan modules according to the invention.

Further details and advantageous embodiments of the invention can be found in the following description, on the basis of which one embodiment of the invention will be described and explained in more detail.

### BRIEF DESCRIPTION OF THE DRAWINGS

In the drawings:

FIG. 1 is a view of a reflow soldering system;

FIG. 2 shows a fan module of the reflow soldering system according to FIG. 1 in an isometric view;

FIG. 3 shows the fan module according to FIG. 2 in side view;

FIG. 4 is a longitudinal section through the fan module according to FIG. 3 along the line IV; and

FIG. 5 is a longitudinal section through a fan module installed in the reflow soldering system according to FIG. 1.

### DETAILED DESCRIPTION

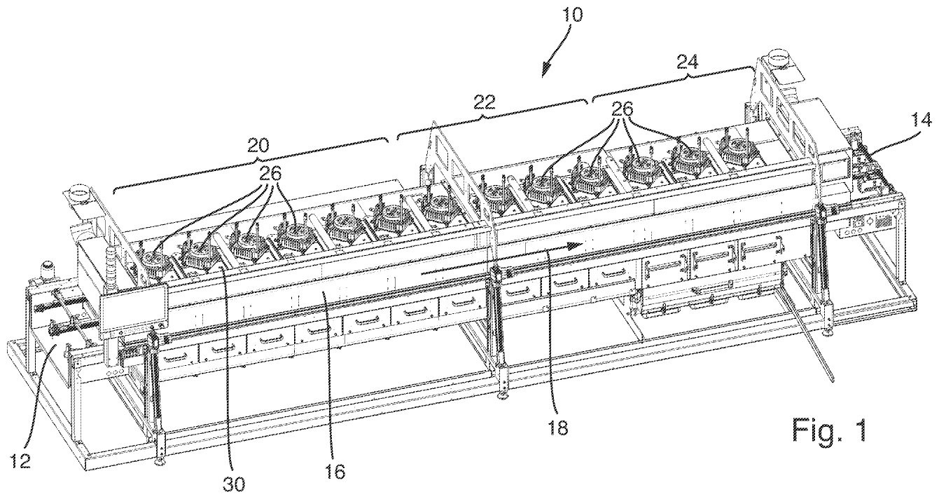

FIG. 1 shows a soldering system 10 which is designed as a reflow soldering system. The soldering system 10 is shown without a cover, so that components of the soldering system lying under the cover are clearly visible.

The soldering system is used for continuous soldering of items to be soldered and has an input 12 and an output 14. The item to be soldered enters the soldering system 10 via the input and the soldered item is removed from the soldering system 10 via the output. The item to be soldered is transported along a transport direction 18 through the soldering system 10 via a process channel 16 extending over the entire length of the soldering system 10.

A preheating zone 20, a soldering zone 22, and a cooling zone 24 are provided in the process channel 16. During the operation of the soldering system 10, the item to be soldered, that is, the printed circuit board provided with solder paste and fitted with electronic components, is first heated in the preheating zone 20 to a temperature which is below the melting temperature of the solder paste. In the soldering zone 22, the printed circuit board is heated for a specific period to a process temperature which is above the melting point of the solder paste, so that it melts in the soldering zone to solder the electronic components to the printed circuit board. The item to be soldered is cooled in the cooling zone 24, so that the liquid solder solidifies before the soldered item is removed at the output 14 of the soldering system 10.

As is clear from FIG. 1, a plurality of fan modules 26 are provided on the top side of the process channel 16. Accordingly, fan modules 26 are also provided on the bottom side of the process channel 16 and are covered by the process channel 16 in the view according to FIG. 1, and are therefore not visible. With the fan modules 26, a defined ventilation or air flow can be provided in the process channel 16 in the particular zones 20, 22, 24 in order to achieve an atmosphere to be provided in each case.

The fan modules 26 shown in FIG. 1 and the fan modules provided on the bottom side of the process channel 16, which modules cannot be seen in FIG. 1, are each of identical construction.

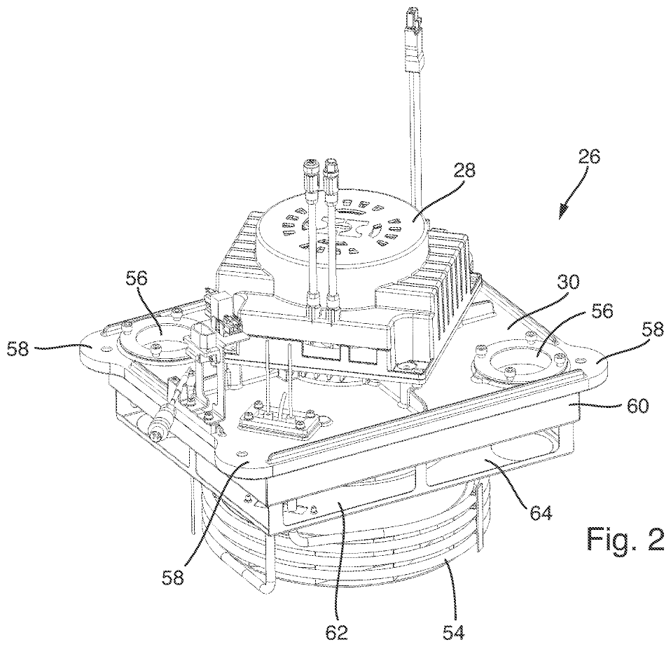

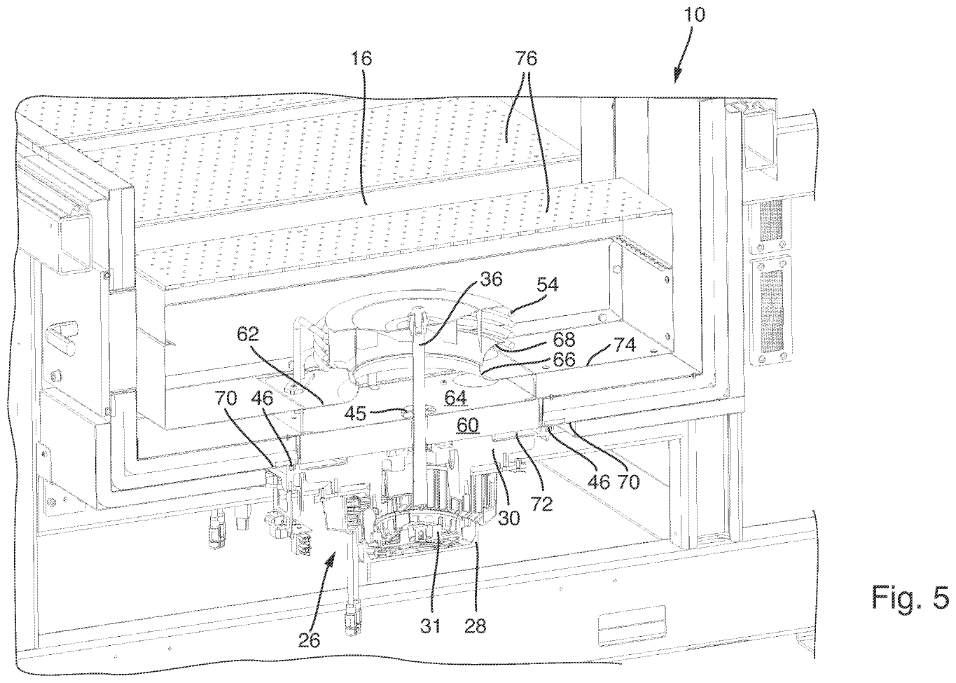

One of these fan modules 26 is shown in FIGS. 2, 3 and 4 as a single module. As is clear from FIGS. 2, 3 and 4, the fan module 26 has a cover 28 which sits on a flange plate 30. As is clear from the section according to FIG. 4, a housing-like support part 31 in which a first shaft bearing 32 is accommodated is provided under the cover 28. Furthermore, a stator 34 is fastened in the support part 31 and interacts electromotively with a rotor 38 arranged non-rotatably on a rotor shaft 36. The rotor shaft 36 extends along an axis of rotation 37. The stator 34 can provide electromagnetic coils, and the rotor 38 can provide magnets, cages or laminated cores cooperating with the coils. The arrangement is then such that, when the coils are energized, the rotor 38, and thus the rotor shaft 36, rotates.

As is clear from the section according to FIG. 4, the flange plate 30 has an aperture 40 through which the rotor shaft 36 extends. A second shaft bearing 42 is provided in the aperture 40 and, together with the first shaft bearing 32, ultimately supports the rotor shaft 36. A shaft seal 44 for sealing the stator 34 and rotor 38 is provided in the aperture 40 next to the shaft bearing 42. Another shaft seal 45 is provided between the separating panel 46 and the insulating plate 60.

In the embodiment shown in the figure, the shaft seal 44 is provided on the side of the second shaft bearing 42 facing the first shaft bearing 32; according to the invention, it is also conceivable that the shaft seal 44 is arranged on the side of the second shaft bearing 42 facing away from the first shaft bearing 32.

The flange plate 30 is designed in such a way that, in the assembled state shown in FIGS. 1 and 5, it completely covers and closes off a channel opening in the process channel 16. For secure sealing of the process channel, the flange plate 30 has a seal 46 on its side facing away from the stator 34, which seal is designed as a circumferential ring seal situated in a groove 48.

As is also clear from FIG. 4 in particular, a fan wheel 50 is arranged on the rotor shaft 36 in a rotationally fixed manner on the rotor shaft 36 on the side facing away from the first shaft bearing 32. Consequently, rotating the rotor shaft 36 generates an air flow through the fan wheel 50.

The flange plate 30 is larger than the fan wheel 50 in the direction running perpendicular to the rotor shaft 36. Consequently, the outer edge 52 of the flange plate 36 protrudes in the radial direction beyond the fan wheel 50. This ensures that the fan module 26 can be inserted into a channel opening in the process channel 16, which opening is then reliably sealed by the seal 46 in the assembled state.

As is also clear from FIGS. 2, 3 and 4, a heating element 54 that surrounds the fan wheel 50 in the radial direction is provided. The heating element 54 runs along a helical line and can in particular be designed as a resistance heating element. The heating element is preferably attached to the flange plate 30.

As is clear from the view according to FIG. 2, the flange plate 30 has openings 56 which are used for the supply and/or discharge of process gas. Furthermore, locking portions 58 are provided on the flange plate 30 by means of which locking portions the flange plate 30, and thus the entire fan module 26, can be fastened to the channel components that form the process channel 16. According to FIG. 2, the locking portions 58 have holes through which fastening screws can be passed.

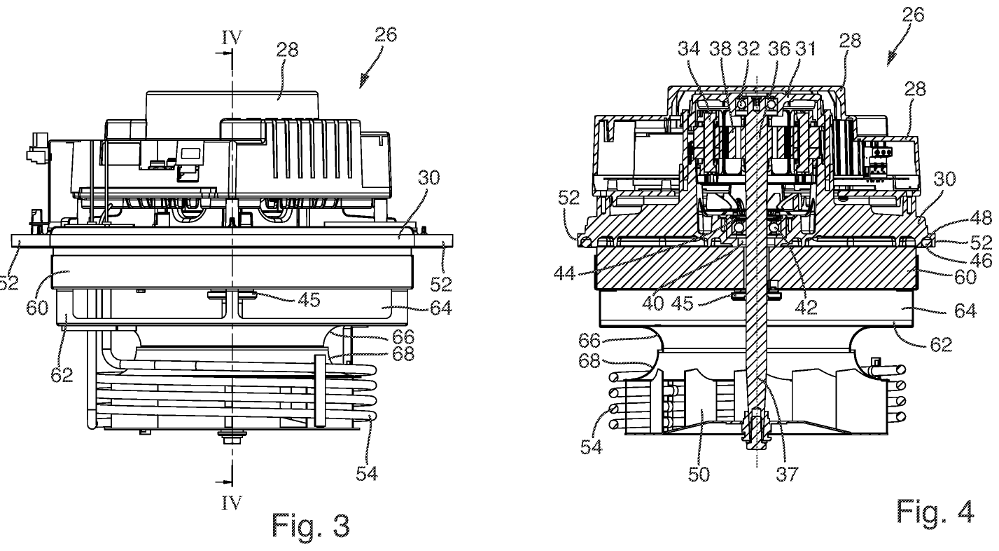

On the side facing away from the stator, the flange plate 30 has an insulating plate 60 in order to thermally insulate the process channel 16 from the outside. Furthermore, a separating panel 62, which separates the interior of the process channel 16 from a suction channel 64 formed by the separating panel 62, is provided on the flange plate 30. As is clear in particular from FIGS. 3 and 4, the insulating plate 60 lies between the flange plate 30 and the separating panel 62.

As is also clear in particular from FIGS. 3 and 4, a circumferential collar 66 extending toward the fan wheel 50 is provided on the separating panel 62 and is used for guiding the air flow toward the fan wheel 50. As is particularly clear from FIGS. 3 and 4, the collar 66 has a rounded design in the longitudinal section.

The fan wheel has a circumferential shoulder 68 which corresponds to the collar 66 and has a rounded design corresponding to the collar 66. In this way, an advantageous flow of air from the collar 66 toward the shoulder 68 is achieved. In operation, the shoulder 68, in contrast to the collar 66, rotates together with the fan wheel 50.

FIG. 5 shows the installation situation of a fan module 26 in the soldering system 10 in section, wherein some components of the fan module 26, for the sake of clarity, are not shown. It can be clearly seen that the flange plate 30 with the seal 46 is in sealing contact with the channel components 70. The flange plate 30 closes off a channel opening 72 through which the fan wheel protrudes in the process channel 16. The insulating plate 60 for thermal insulation lies within the channel opening 72. Furthermore, it can be seen that the separating panel 62 lies in a plane with further channel panels 74 that form the suction chamber 64. In addition, diffuser panels 76, which are intended to provide a uniform air flow in the process channel, can be seen in the process channel 16.

The described fan module 26 can be installed and removed in the soldering system 10 in a simple manner. For this purpose, the flange plate 30 is placed on the particular channel opening 72 to be provided, so that the fan wheel 50 with the heating elements 52 protrudes into the process channel 16. After that, it is only a matter of fastening the fan module 26 to the channel components 70 with the locking portions 58 and making the electrical connections. An exact alignment or adjustment of the rotor shaft 36 or the shaft seals 44, 45 is not necessary, because the entire module 26 can be inserted as a prefabricated unit into the soldering system 10. Even if, as shown in FIG. 1, a large number of fan modules 26 are used, they can be assembled or disassembled relatively quickly. Elaborate alignment and sealing of the rotor shaft 36 during installation in the system 10 is not necessary.

1. A fan module for a soldering system for circulating air in a process channel of the soldering system, the module having
a. a housing-like support part,
b. a first shaft bearing provided in or on the support part,
c. a motor, which comprises a stator and a rotor which cooperates with the stator,
d. a rotor shaft provided on the rotor,
e. a fan wheel provided on the rotor shaft and having a second shaft bearing for supporting the rotor shaft,
f. wherein the fan module comprises a flange plate, which in the assembled state covers a channel opening in the process channel and which comprises an aperture in or on which the second shaft bearing is provided.

2. The fan module according to claim 1, wherein a shaft seal for sealing the rotor shaft is provided in or on the aperture.

3. The fan module according to claim 1, wherein the flange plate is designed to be larger in directions extending perpendicularly to the rotor shaft than the fan wheel-.

4. The fan module (26) according to claim 1, wherein the flange plate has openings for supplying and discharging process gas.

5. The fan module according to claim 1, wherein the flange plate (30) has a seal (46) for sealing the flange plate (30) against the channel components (70) that form the process channel (16).

6. The fan module according to claim 1, wherein the flange plate has locking portions for fastening to the channel components that form the process channel.

7. The fan module according to claim 1, wherein the flange plate has fastening portions for fastening heating elements and/or other components located in the process channel.

8. The fan module according to claim 1, wherein the flange plate has insulation on the side facing away from the stator.

9. The fan module according to claim 1, wherein the flange plate has a separating panel on the side facing away from the stator, which panel separates the interior of the process channel from a suction channel.

10. The fan module according to claim 9, wherein the separating panel has a peripheral collar pointing away from the flange plate for guiding the air flow toward the fan wheel-.

11. The fan module according to claim 10, wherein the fan wheel has a circumferential shoulder corresponding to the collar.

12. The fan module according to claim 1, wherein the flange plate is produced in the die-casting process.

13. A soldering system having one or more fan modules for circulating air in a process channel of the soldering system, the module having
a. a housing-like support part,
b. a first shaft bearing provided in or on the support part,
c. a motor, which comprises a stator and a rotor which cooperates with the stator,
d. a rotor shaft provided on the rotor,
e. a fan wheel provided on the rotor shaft and having a second shaft bearing for supporting the rotor shaft,
f. wherein the fan module comprises a flange plate, which in the assembled state covers a channel opening in the process channel and which comprises an aperture in or on which the second shaft bearing is provided.
